(19) United States
(12) Patent Application Publication
(10) Pub. No.: US 2021/0189570 A1
(43) Pub. Date: Jun. 24, 2021

(54) OLEOPHOBIC AND HYDROPHILIC CONDUCTIVE COATING FOR IMPRESSED CURRENT CATHODIC PROTECTION ANODE

(71) Applicant: Saudi Arabian Oil Company, Dhahran (SA)

(72) Inventors: Turki A. Al-Khaldi, Dhahran (SA); Ebadul Z. Al Haque, Dhahran (SA); Balasubramani Bakthavatchalu, Dhahran (SA)

(21) Appl. No.: 16/725,299

(22) Filed: Dec. 23, 2019

(51) Int. Cl. C23F 13/16

(52) U.S. Cl. CPC C23F 13/16

(57) ABSTRACT

A cathodic protection system that comprises a vessel for containing a fluid, an anode positioned inside the vessel, a hydrophilic and oleophobic coating covering at least a portion of the anode, wherein the coating allows ions to pass therethrough and repels oil and wax contaminants from reaching at least a portion of the anode, and an impressed current source electrically connected to the anode and the vessel, the vessel being a cathode when current is applied from the current source. A corrosion protection method coats at least a portion of a suitably sized anode, with a material having hydrophilic and oleophobic properties, positions the coated anode in the vessel, and fills the vessel with fluid. A voltage is applied between the vessel and the anode so that ions flow from the anode, through the fluid, to the vessel.

### FIELD OF THE DISCLOSURE

The present disclosure relates to corrosion prevention, and more particularly relates to an oleophobic and hydrophilic conductive coating for an impressed current cathodic protection anode.

### BACKGROUND OF THE DISCLOSURE

Cathodic protection (“CP”) systems are used to protect metallic structures from corrosion. There are two types of CP systems: galvanic anode “sacrificial anode” cathodic protection (“GACP”) and impressed current anode cathodic protection systems. In GACP, metallic structures can be protected from corrosion by being positioned as a cathode in an electrochemical cell that includes an anode composed of a more highly reactive metal than the cathode. Due to the difference in the natural potentials between the anode and the protected metal, the more reactive anode corrodes in preference to the protected metal structure, thereby preventing corrosion of the protected metal. In GACP, the anode corrodes instead of the protected metal (the cathode), until the anode material is depleted.

In contrast, an impressed current anode system depends on external power source to provide current output to protect the cathode from corrosion which is the metallic structure. Impressed-current cathodic protection systems employ D/C power (e.g., rectified A/C power) to impress a current between one or more anodes and the cathode. The impressed current anode is made of a dimensionally stable material (e.g., MMO, PtNb) such that the material is not consumed or has minimal consumption during operation

To date, there have been challenges using impressed current anodes in oil and gas infrastructure due to wax and other oily deposits that tend to accumulate on the surface of impressed CP anode, preventing the emission of current from the anode to protect the internal structure from corrosion.

### SUMMARY OF THE DISCLOSURE

The present disclosure provides a cathodic protection system that comprises a vessel for containing a fluid, an anode positioned inside the vessel, a hydrophilic and oleophobic coating covering at least a portion of the anode, wherein the coating allows ions to pass there through and repels oil and wax contaminants from reaching at least a portion of the anode, and an impressed current source electrically connected to the anode and the vessel, the vessel being a cathode when current is applied from the current source.

In certain embodiments, the coating includes a composition that has both conductive and oleophobic properties. In certain implementations, the composition comprises a single layer coating having conductive and oleophobic properties, such as graphene oxide (GO) which, in and of itself, is both conductive and Oleophobic. In certain other embodiments, the coating includes a conductive filler material and an oleophobic binder.

In further embodiments, the coating includes particulate conductive functional additives and an oleophobic binder. In still other embodiments, the coating contains two distinct layers including a first conductive layer in contact with the anode, and a second oleophobic layer positioned over the first layer. The coating can also include a composition made of a metal and a non-metallic organic or inorganic material and an oleophobic binder.

In certain embodiments, the coating comprises a thin film having a thickness ranging from about 100 microns to about 900 microns. In other embodiments, the coating comprises an ultrathin film having a thickness ranging from about 10 microns to about 99 microns.

Embodiments of the present disclosure further includes a method of providing corrosion protection to a vessel. The method comprises the steps of providing an anode sized to provide a predetermined amount of cathodic protection at a predetermined voltage, based on the fluids and conditions expected in the vessel, the size of the vessel, and the number of anodes to be used, coating at least a portion of the anode with a material having hydrophilic and oleophobic properties, positioning the coated anode in the vessel, and filling the vessel with fluid and applying a voltage between the vessel and the anode so that ions flow from the anode, through the fluid, to the vessel.

These and other aspects, features, and advantages can be appreciated from the following description of certain embodiments and the accompanying drawing figures and claims.

### BRIEF DESCRIPTION OF THE DRAWINGS

FIG. 1 is a schematic cross-sectional view of an impressed current cathodic protection system according to an embodiment of the present disclosure.

FIG. 2 is a schematic cross-sectional view of the impressed current anode according to an embodiment of the present disclosure.

### DETAILED DESCRIPTION OF CERTAIN EMBODIMENTS OF THE DISCLOSURE

Disclosed herein is a dimensionally stable impressed current precious anode, such as Mixed Metal Oxide (“MMO”), platinized niobium (“PtNb”) or platinized titanium (“PtTi”) anode that is coated with an oleophobic (oil-repellant) or hydrophilic (water-attracting) conductive coating. An impressed current anode of the type disclosed herein enables utilization of impressed current CP anodes in wet, sour or sweet environments such as, but not limited to high pressure production traps (HPPT), low pressure production traps (LPPT), water/oil Separation Plants (“WOSEP”), desalters and dehydrators. Sufficient corrosion protection inside the vessel is ensured by the dimensionally stable impressed current anode with oleophobic or hydrophilic coating in cases in which galvanic sacrificial anodes might be completely depleted during operation. Moreover, the impressed current anode has the advantages of being much lighter than galvanic CP anodes and their performance can be easily adapted by monitoring the current used for corrosion protection and making any adjustments to the current indicated by feedback from the monitoring.

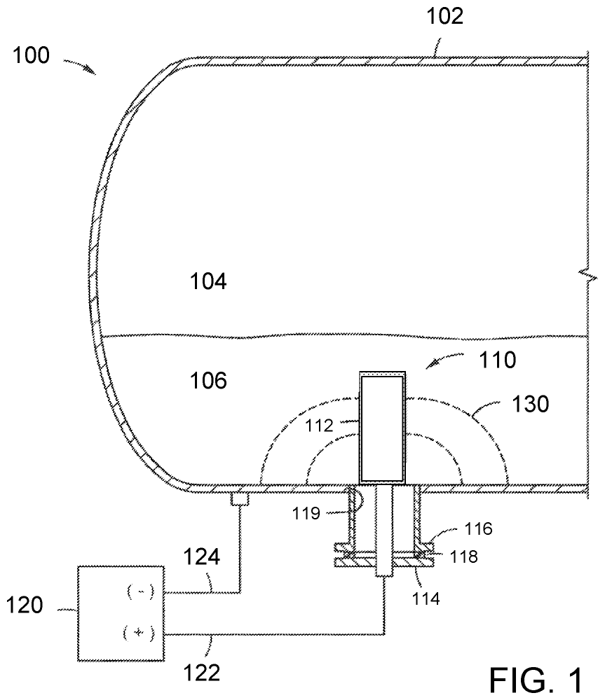

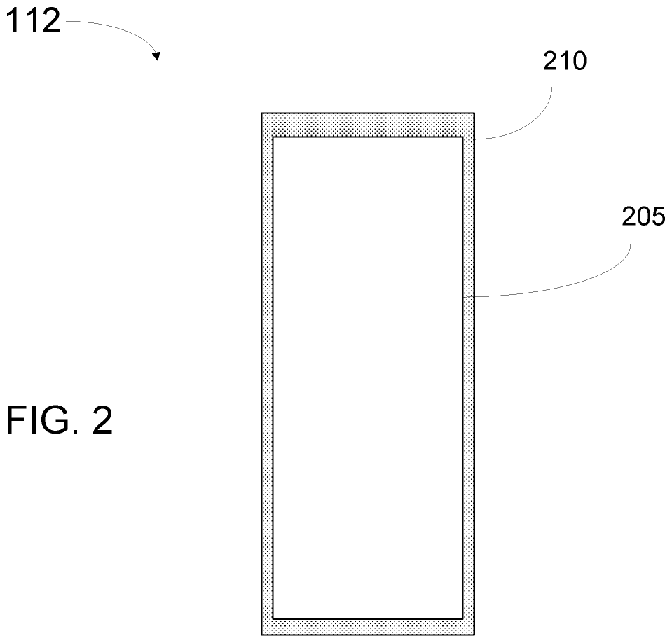

FIG. 1 is a schematic cross-sectional view of an impressed current cathodic protection system 100 according to the present disclosure. System 100 includes a protected metal structure to be protected from corrosion, such as vessel 102. Vessel 102 can be, for example, a storage tank, processing equipment or other structure used for storing, processing or transporting fluids. In some implementations, embodiments, vessel 102 can be, for example, a high-pressure production trap, a low-pressure production trap, a water and oil separation plant, a desalter, or a dehydrator. In the embodiment depicted, in FIG. 2, vessel 102 is a storage vessel for storing or separating a fluid such as wet crude petroleum. Wet crude is crude oil having droplets of water suspended therein. Over time, the fluids separate to form a first phase 104 and a second phase 106 within the vessel as shown. As water is denser than oil, the top phase 104 is predominantly composed of oil and the second phase 106 is predominantly composed of water. Corrosion is most likely to occur in water phase 106. The pace of corrosion can be high due to conditions inside vessel such as low resistivity, high temperature (for example, greater that 50 degrees Celsius), high total dissolved solids, and a high percentage of H₂S.

An immersed current protection anode assembly 110 (“anode assembly”) is positioned at the bottom of the vessel 102. In some embodiments, a plurality of anode assemblies can be installed and spaced apart around the interior surfaces of vessel 102. For example, a large storage vessel can have as many as 50 anode assemblies 110, although more or fewer anode assemblies can be used. The anode assembly 110 is in contact with the second phase 106 in which corrosion is more likely to occur. The anode assembly 110 includes an anode 112 mounted on an anode mount 114. The anode mount 114 is mechanically connected to a flange 116 of vessel 102. The anode 112 is electrically isolated from the vessel 102, by, for example, using a non-conductive mount or by positioning an insulator such as insulated spacer 118 between the mount 114 and vessel 102. The anode 112 can be tubular in shape as shown although it can be other shapes as well (such as rectangular). The diameter of the anode 112 typically varies from about 10 mm to about 25 mm and the length of the anode typically varies from varies from about 100 mm to 1000 mm.

The mount 114 is positioned above an orifice 119 through which one of the lines 122 of a power supply 120 is coupled to the anode 112. Power supply 120 is a direct current (“DC”) power supply having a positive line 122 connected to the anode 112, and a negative line 124 coupled to the vessel 102. The power supply 120 can be connected to an alternating current (“AC”) power source and can include a rectifier for converting the AC electricity into DC electricity. When electric current is applied by power supply 120, electric current flows from the vessel 102 to anode 112 and ions 130 flow from the anode 112 to the vessel 102. In this manner, the anode 112 provides corrosion protection to vessel 102.

FIG. 2 is a schematic cross-sectional view of the impressed current anode 112. The anode 112 includes a metallic portion 205 made of a dimensionally stable such as mixed metal oxide (“MMO”), platinized niobium (“PtNb”), or platinized titanium (“PtTi”). The term “dimensionally stable” as used herein denotes that the anode does not change shape (or changes shape minimally) during operation for at least a predetermined amount of time. The dimensional stability is maintained even in the presence of corrosion to the material properties of the particular metals of which the metallic portion 205 is composed. The predetermined amount of time can be between 3 and 15 years. The anode size is selected to provide a predetermined amount of cathodic protection at a given voltage, based on the fluids and conditions expected in the vessel, the size of the vessel, and the number of anodes to be used. In some implementations, the active anode surface comprises iridium oxide (IrO₂) and tantalum oxide (Ta₂O₅).

The anode 112 also includes a hydrophilic conductive coating 210 that covers a portion of or the entire surface of the metallic portion 205 that is exposed to the fluid phase in the vessel. In varying embodiments, one or more conductive oleophobic (oil repellant) and hydrophilic coating layers are utilized to repel oil, keeping the anode surface free of oil deposits which can reduce its effectiveness. The coating 210 is electrically conductive and allows ions and electrons to pass through. The conductive coating 210 can be applied to the metallic portion 205 during construction by dipping, or spray, or brush, or electrodeposition, etc. The coating can be a single or multilayer conductive coating. The coating can be acid resistant and, more specifically, can be resistant to hydrogen sulfide gas (H₂S).

After curing, the coating solidifies, yielding an oil-repellant surface with high conductivity. The coating 210 permits the anode to discharge a current while having the ability to repel wax-like materials and other oily contaminants. The coating 210 can be nonporous, semi-porous or porous and can vary in thickness from thin, ranging from about 100 microns to about 900 microns, to ultrathin, ranging from about 10 microns to about 99 microns.

The coating for the impressed current anode can be produced in a number of ways. In one embodiment, the coating can be composed of a single composition having conductive and oleophobic properties, such as graphene oxide (GO) which, in and of itself, is both conductive and oleophobic. In another embodiment, the coating comprises a conductive filler material combined with an oleophobic binder. In still another embodiment, the coating contains one or more particulate conductive materials such as graphene particles, single-walled nanotubes (SWNT), conductive polymers or other conductive particulates as functional additives combined with an oleophobic binder. In another embodiment, the coating comprises two distinct layers: a first conductive layer composed of conductive materials, and a second layer composed of an oleophobic coating. The second layer can be sprayed on the first layer, protecting the conductive first layer from wax and oil contaminants. In some implementations, the coating can include a conductive portion made of a composite of a metal and an organic or inorganic (non-metallic) material with an oleophobic binder.

The impressed current anode of the present disclosure with a thin-film oleophobic coating overcomes many challenges to the effective utilization of impressed current anodes. The coated anodes can function until a scheduled inspection interval of the vessel and can also be externally monitored. Unlike conventional impressed current anodes which use heavy cementitious coating materials, the disclosed anode using a thin film coating system that does not require a large mass of material. Therefore, there is no significant change in the weight or dimensions of the impressed current anode when the coating is applied. In addition, the coating of the present disclosure does not need to expose the impressed current anode to elevated pressures as commonly occurs in conventional impressed current anodes.

Furthermore, the oleophobic-coated impressed current anode of the present disclosure can be used in in wet sour or sweet environment such as, High Pressure Production Traps (HPPT), Low Pressure Production Traps (LPPT), Water and Oil Separation Plants (“WOSEP”), Desalters and/or Dehydrators. The coated anode assures sufficient corrosion protection inside the vessel for a lengthy period without depletion. Importantly, the current applied to anode can be adjusted externally and the electric current can be monitored to provide sufficient corrosion protection.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components or steps described and illustrated with reference to the figures are required for all embodiments or arrangements.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and “comprising”, when used in this specification, specify the presence of stated features, integers, steps, operations, elements, or components, but do not preclude the presence or addition of one or more other features, integers, steps, operations, elements, components, or groups thereof.

Terms of orientation are used herein merely for purposes of convention and referencing and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A cathodic protection system, the cathodic protection system comprising:
a vessel for containing a fluid;
an anode positioned inside the vessel;
a hydrophilic and oleophobic coating covering at least a portion of the anode, wherein the coating allows ions to pass therethrough and repels oil and wax contaminants from reaching at least a portion of the anode; and
an impressed current source electrically connected to the anode and the vessel, the vessel being a cathode when current is applied from the current source;
wherein the coating has a thickness ranging from about 10 microns to about 900 microns.

2. The cathodic protection system of claim 1, wherein the coating includes a composition that has both conductive and oleophobic properties.

3. The cathodic protection system of claim 2, wherein the composition of the coating has conductive and oleophobic properties.

4. The cathodic protection system of claim 3, wherein the coating comprises a single layer.

5. The cathodic protection system of claim 4, wherein the single layer coating comprises graphene oxide (GO).

6. The cathodic protection system of claim 1, wherein the coating includes a conductive filler material and an oleophobic binder.

7. The cathodic protection system of claim 1, wherein the coating includes particulate conductive functional additives and an oleophobic binder.

8. The cathodic protection system of claim 1, wherein the coating contains two distinct layers including a first conductive layer in contact with the anode, and a second oleophobic layer positioned over the first layer.

9. The cathodic protection system of claim 1, wherein the coating includes a composition made of a metal and a non-metallic organic or inorganic material and an oleophobic binder.

10. (canceled)

11. The cathodic protection system of claim 1, wherein the coating has a thickness ranging from about 10 microns to about 99 microns.

12. A method of providing corrosion protection to a vessel, the method comprising the steps of:
providing an anode sized to provide a predetermined amount of cathodic protection at a predetermined voltage, based on the fluids and conditions expected in the vessel, the size of the vessel, and the number of anodes to be used;
coating at least a portion of the anode with a coating having hydrophilic and oleophobic properties;
positioning the coated anode in the vessel; and
filling the vessel with fluid and applying a voltage between the vessel and the anode so that ions flow from the anode, through the fluid, to the vessel;
wherein the coating has a thickness ranging from about 10 microns to about 900 microns.

13. The method of claim 12, wherein the coating includes a composition that has both conductive and oleophobic properties.

14. (canceled)

15. The method of claim 14, wherein the coating step comprises applying a single layer coating to the anode.

16. The method of claim 12, wherein the coating comprises graphene oxide (GO) binder.

17. The method of claim 12, wherein the coating includes a conductive filler material and an oleophobic binder.

18. The method of claim 12, wherein the coating includes particulate conductive functional additives and an oleophobic binder.

19. The method of claim 12, wherein the coating contains two distinct layers including a first conductive layer in contact with the anode, and a second oleophobic layer positioned over the first layer.

20. The method of claim 12, wherein the coating includes a composition made of a metal and a non-metallic organic or inorganic material and an oleophobic binder.

21. (canceled)

22. The method of claim 12, wherein the coating has a thickness ranging from about 10 microns to about 99 microns.

23. A cathodic protection system, the cathodic protection system comprising:
a vessel for containing a fluid;
an anode positioned inside the vessel;
a hydrophilic and oleophobic coating covering at least a portion of the anode, wherein the coating allows ions to pass therethrough and repels oil and wax contaminants from reaching at least a portion of the anode; and
an impressed current source electrically connected to the anode and the vessel, the vessel being a cathode when current is applied from the current source;
wherein the coating has a thickness ranging from about 10 microns to about 99 microns.
